(19) United States
(12) Patent Application Publication
(10) Pub. No.: US 2026/0074466 A1
(43) Pub. Date: Mar. 12, 2026

(54) COVER, ELECTRONIC DEVICE, AND CONNECTOR UNIT REMOVING METHOD

(71) Applicant: WNC Corporation, Hsinchu (TW)

(72) Inventors: Chien-Hung LEE, Hsinchu (TW); Ying-Chih LIU, Hsinchu (TW); Chung-Hau WANG, Hsinchu (TW)

(21) Appl. No.: 19/319,820

(22) Filed: Sep. 5, 2025

(30) Foreign Application Priority Data
Sep. 9, 2024 (TW) 113134084

(51) Int. Cl. H01R 13/633; H01R 43/26

(52) U.S. Cl. CPC H01R 13/633; H01R 43/26

(57) ABSTRACT

A cover, an electronic device, and a connector unit removing method are provided. The cover is configured for corresponding and being adjacent to a connector unit of an electronic device and includes a first surface, a second surface, a pulling portion and at least one first engaging portion. The first surface is configured to face an outer space of the electronic device. The second surface is disposed opposite to the first surface and configured to face an inner space of the electronic device. The pulling portion includes an opening that penetrates the first surface and the second surface. When the connector unit is in a transmission state, the opening is configured for a cable to pass therethrough to connect to the connector unit. The first engaging portion is disposed on the second surface.

### RELATED APPLICATIONS

This application claims priority to Taiwan Application Serial Number 113134084, filed September 09, 2024, which is herein incorporated by reference.

### BACKGROUND

### TECHNICAL FIELD

The present disclosure relates to a cover, an electronic device, and a connector unit removing method. More particularly to a cover, an electronic device, and a connector unit removing method that facilitates the removal of a connector unit.

### DESCRIPTION OF RELATED ART

With the ever-increasing expectations for technological advancements, connectors with higher processing speeds are required to meet the demands for higher transmission speeds. Therefore, connectors need to be equipped with heat dissipation structures to solve their heat dissipation problems. However, when the connector needs to be removed from the electronic device for relocation or replacement, the user's fingers may get burned due to accidentally touching the heat dissipation structure.

In view of this, there is an urgent need to develop a technical solution that can smoothly remove the connector from the electronic device and prevent the user from getting burned in the related industries.

### SUMMARY

According to one aspect of the present disclosure, a cover configured to correspond and be adjacent to a connector unit of an electronic device includes a first surface, a second surface, a pulling portion, and at least one first engaging portion. The first surface is configured to face an outer space of the electronic device. The second surface is disposed opposite to the first surface and configured to face an inner space of the electronic device. The pulling portion includes an opening that penetrates the first surface and the second surface. When the connector unit is in a transmission state, the opening is configured for a cable to pass through to connect to the connector unit. The at least one first engaging portion is disposed on the second surface.

According to another aspect of the present disclosure, an electronic device includes a housing, a connector unit, and a cover. The connector unit is disposed in an inner space of the electronic device. The cover is correspondingly and adjacently disposed to the connector unit, and the cover is connected to the housing and exposed on the outer surface of the housing. The cover is configured to contact and drive the connector unit, so the connector unit is moved from the inner space of the electronic device to the outer space of the electronic device.

According to yet another aspect of the present disclosure, a connector unit removing method is used to remove a connector unit from an electronic device. The electronic device includes a connector unit and a cover. The connector unit is disposed in an inner space of the electronic device, and the cover is correspondingly and adjacently disposed to the connector unit. The cover is connected to a housing of the electronic device and exposed on the outer surface of the housing. The connector unit removing method includes an actuating step, a contacting step, a driving step, and a connector unit removing step. The actuating step includes rotating the cover relative to a cover pivot of the cover or moving the cover along the outer surface of the housing. The contacting step includes causing the cover to contact the connector unit. The driving step includes causing the cover to drive the connector unit. The connector unit removing step includes moving the connector unit from the inner space of the electronic device to the outer space of the electronic device to remove the connector unit from the electronic device.

### BRIEF DESCRIPTION OF THE DRAWINGS

The disclosure can be more fully understood by reading the following detailed description of the embodiments, with reference made to the accompanying drawings as follows:

FIG. 1A is a perspective view of an electronic device according to a first embodiment of the present disclosure;

FIG. 1B is an exploded view of a partial of the electronic device in FIG. 1A;

FIG. 1C is another exploded view of a partial the electronic device in FIG. 1A;

FIG. 1D is a cross-sectional view along line 1D-1D of the electronic device in FIG. 1A;

FIG. 1E is a schematic view of a removal process of a connector unit in the electronic device in FIG. 1A;

FIG. 1F is another schematic view of the removal process of the connector unit in the electronic device in FIG. 1A;

FIG. 2A is an exploded view of a partial of an electronic device according to a second embodiment of the present disclosure;

FIG. 2B is a cross-sectional view of a partial of the electronic device in FIG. 2A after being assembled;

FIG. 2C is a schematic view of a removal process of a connector unit in the electronic device in FIG. 2B; and

FIG. 3 is a flowchart of a connector unit removing method according to a third embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein.

The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first” or “second” can be used to describe various components, signals or the like, which are for distinguishing one component/signal from another one only, and are not intended to, nor should be construed to impose any substantive limitations on the components, signals or the like.

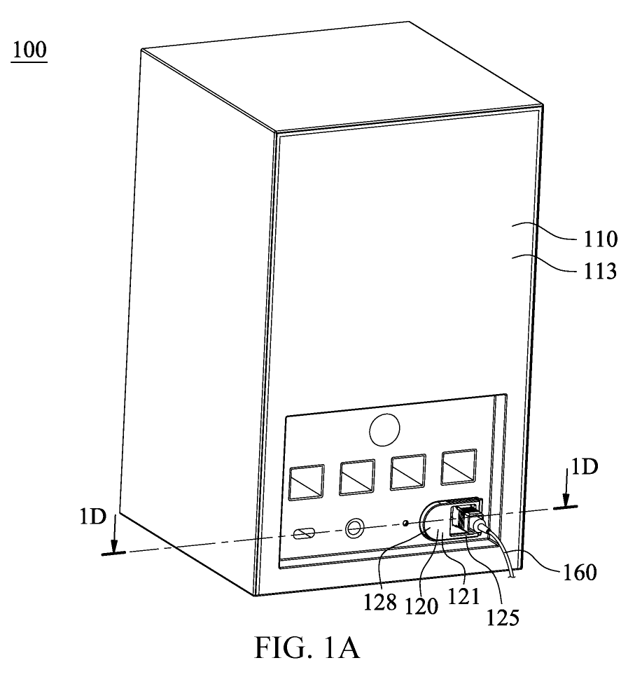

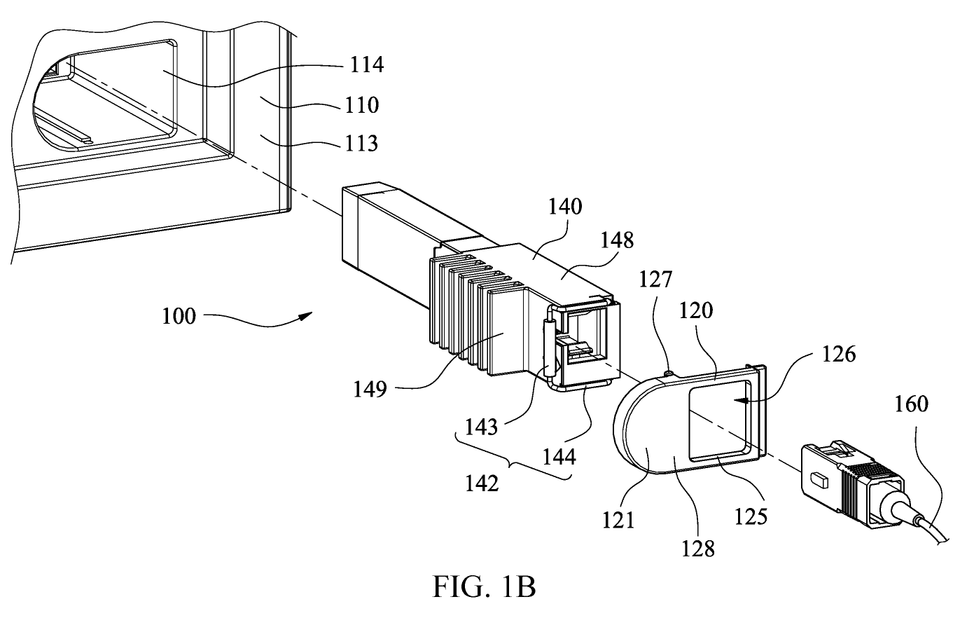

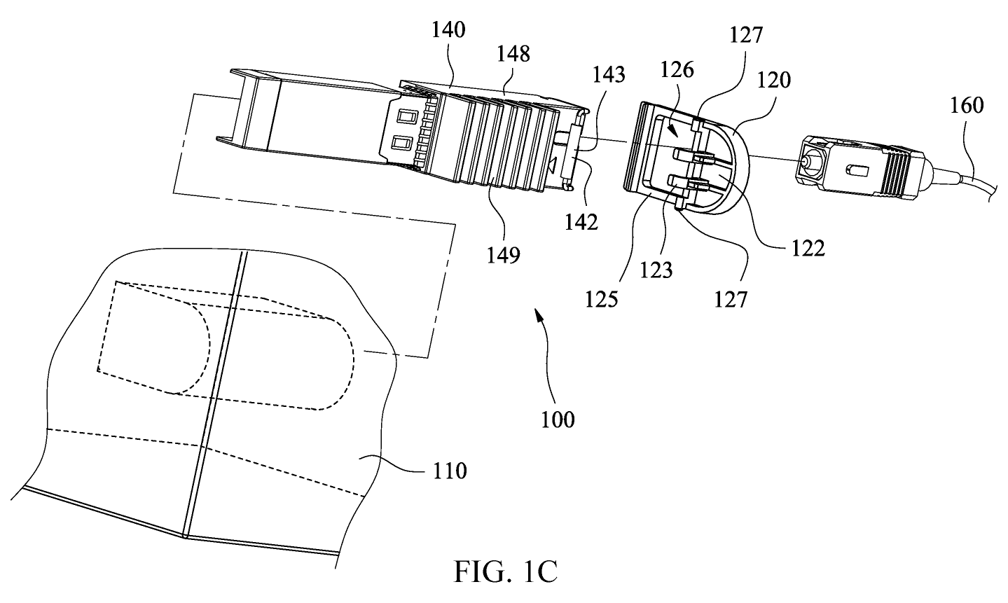

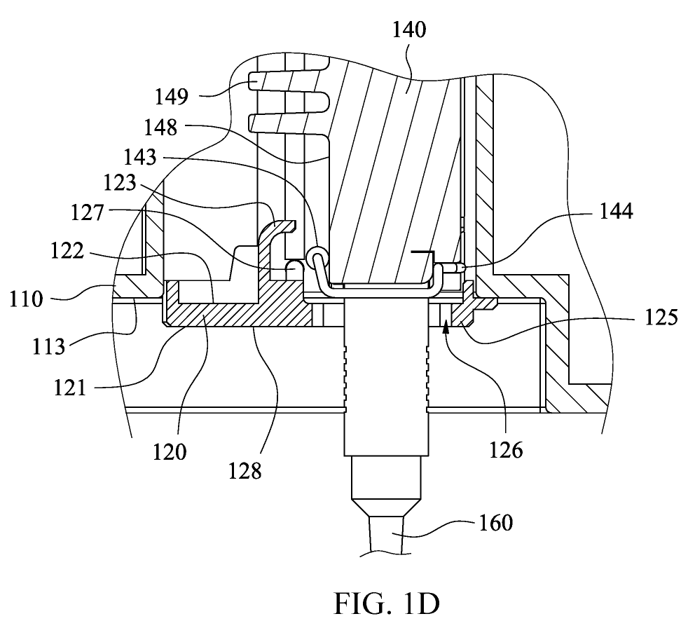

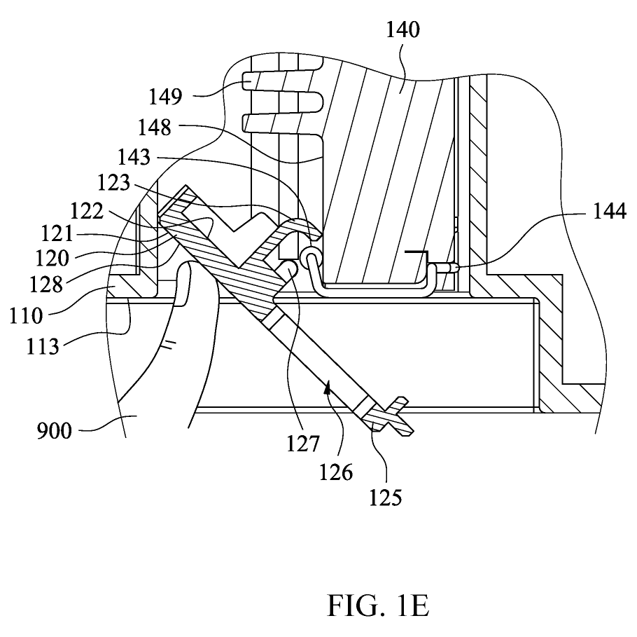

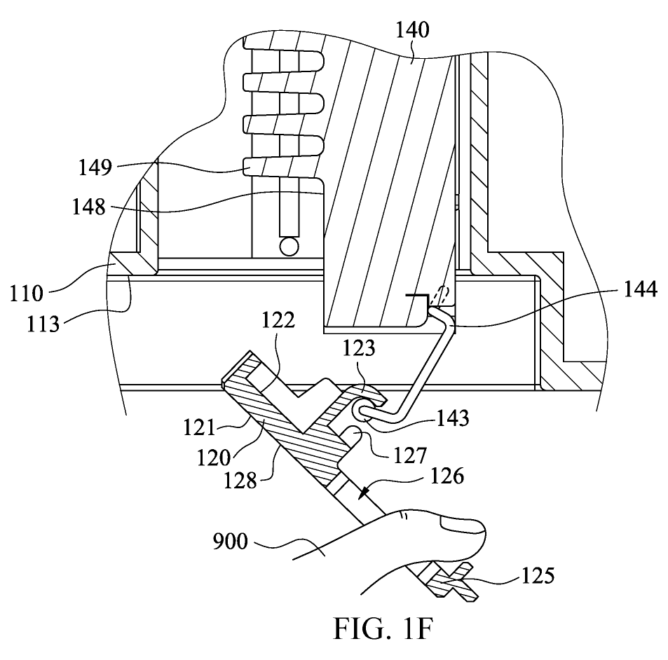

FIG. 1A is a perspective view of an electronic device 100 according to a first embodiment of the present disclosure, FIG. 1B is an exploded view of a partial of the electronic device 100 in FIG. 1A, FIG. 1C is another exploded view of a partial of the electronic device 100 in FIG. 1A, and FIG. 1D is a cross-sectional view along line 1D-1D of the electronic device in FIG. 1A. Referring to FIGS. 1A to 1D, the electronic device 100 includes a housing 110, a connector unit 140, and a cover 120. The connector unit 140 is disposed in an inner space of the electronic device 100. The cover 120 is correspondingly and adjacently disposed to the connector unit 140, and the cover 120 is connected to the housing 110 and exposed on the outer surface 113 of the housing 110. The cover 120 is configured to be able to contact and drive the connector unit 140, moving the connector unit 140 from the inner space of the electronic device 100 to an outer space of the electronic device 100. Thus, the cover 120 can maintain the appearance of the electronic device 100 and facilitate the removal of the connector unit 140.

Specifically, the connector unit 140 may include a heat dissipation structure 149, which is connected to a connector body 148 and made of metal material, and the cover 120 is made of plastic material. Thus, the user does not need to touch the connector unit 140 but can remove the connector unit 140 through the linkage of the cover 120 thereto, avoiding burns caused by accidentally touching the heat dissipation structure 149 during the removal process of the connector unit 140. In the first embodiment, the heat dissipation structure 149 is a fin-type heat dissipation structure, but the present disclosure is not limited thereto.

The connector unit 140 can be an optical fiber transmission connector unit 140. Thus, the electronic device 100 and its cover 120 can be applied when there is a need to remove connector units 140 for relocation or replacement. In the first embodiment, the electronic device 100 can be a router, and the connector unit 140 can further be an SFP (Small Form-Factor Pluggable) stick for optical fiber transmission, but the present disclosure is not limited thereto.

FIG. 1E is a schematic view of a removal process of the connector unit 140 in the electronic device 100 in FIG. 1A. Referring to FIGS. 1A to 1E, after a user 900 performs an action on the cover 120, the cover 120 can contact and drive the connector unit 140. The action includes at least one of a rotation and a movement. Thus, the connector unit 140 can be stably installed but also conveniently removed.

When the action performed by the user 900 on the cover 120 includes rotation, the cover 120 includes a first surface 121, a second surface 122, a cover pivot 127, and a pressing portion 128. The first surface 121 faces the outer space of the electronic device 100, and the second surface 122 is disposed opposite to the first surface 121 and faces the inner space of the electronic device 100. The cover pivot 127 is pivotally connected to a recess (not shown) on an opening periphery 114 of the housing 110, and the pressing portion 128 is disposed on the first surface 121.

Referring to FIG. 1E, when the user 900 presses the pressing portion 128, the pressing portion 128 rotates relative to the cover pivot 127 from the outer space to the inner space of the electronic device 100, causing the cover 120 to contact the connector unit 140. Thus, the cover 120 is convenient to install on the electronic device 100 and drive the connector unit 140 during removal.

The cover 120 can further include at least one first engaging portion 123 disposed on the second surface 122. The first engaging portion 123 can latch (buckle or hook) and drive the connector unit 140. Thus, the cover 120 helps to link with the connector unit 140 during removal.

The connector unit 140 can include a connector body 148 and a second engaging portion 142. The second engaging portion 142 is connected to the connector body 148, and the first engaging portion 123 can latch the second engaging portion 142 to drive the connector unit 140. Thus, it is beneficial for the stable movement of the connector unit 140 during removal.

Specifically, the first engaging portion 123 can be a hook, and the second engaging portion 142 can be a pull handle. The second engaging portion 142 includes a pull handle body 143 and two pull handle pivoting portions 144. The first engaging portion 123 can hook the pull handle body 143, and the two pull handle pivoting portions 144 are respectively connected to the two ends of the pull handle body 143 and pivotally connected to the connector body 148. As such, the first engaging portion 123 and the second engaging portion 142 are conveniently engaged with each other after the cover 120 pivots. In other embodiments of the present disclosure (not shown), the first engaging portion of the cover can be a pull handle, the second engaging portion of the connector unit can be a hook, and the first engaging portion can latch the second engaging portion to drive the connector unit, but the present disclosure is not limited thereto.

The number of the first engaging portions 123 can be two, and the two first engaging portions 123 are arranged along the extending direction of the pull handle body 143, as shown in FIG. 1C. Thus, the cover 120 helps to stably drive the connector unit 140. In other embodiments of the present disclosure (not shown), the number of the first engaging portions can be one or more than two.

The cover 120 further includes a pulling portion 125, and the pulling portion 125 is an opening structure and includes an opening 126 that penetrates the first surface 121 and the second surface 122. When the connector unit 140 is in a transmission state, the opening 126 is configured for a cable 160 to pass through to connect to the connector unit 140, and the first engaging portion 123 is configured not to contact the connector unit 140. The first engaging portion 123 is disposed on the second surface 122. Thus, the cover 120 can maintain the aesthetic appearance of the electronic device 100 when the connector unit 140 is in a transmission state and prevent the user 900 from touching the heating part of the connector unit 140 during the removal process. In addition, in the embodiments of the present disclosure, the connector unit and the cable can include male and female connectors and cables for fixed signal connection or power connection.

The pulling portion 125 and the first engaging portion 123 are respectively disposed on two sides perpendicular to the cover pivot 127, such as the left and right sides of the cover pivot 127 as shown in FIG. 1C. Thus, when the cover 120 pivots, the first engaging portion 123 rotates to the inner space of the electronic device 100 for engagement, and the pulling portion 125 rotates to the outer space of the electronic device 100 for the user 900 to pull, thereby enhancing the smoothness of removing the connector unit 140.

FIG. 1F is another schematic view of the removal process of the connector unit 140 in the electronic device 100 in FIG. 1A. Referring to FIGS. 1B to 1F, the pulling portion 125 and the pressing portion 128 are respectively disposed on two sides perpendicular to the cover pivot 127. When the user 900 presses the pressing portion 128, the pulling portion 125 rotates relative to the cover pivot 127 to the outer space of the electronic device 100 (as shown in FIG. 1E), and the cover 120 can further rotate to a position that is 90 degree angle away from the outer surface 113. The pulling portion 125 is configured for the user 900 to pull the cover 120, and the connector unit 140 is driven by the cover 120 to move from the inner space of the electronic device 100 to the outer space of the electronic device 100 (as shown in FIG. 1F). Thus, the user 900 can avoid touching the heating part of the connector unit 140 throughout the entire removal process.

Referring to FIGS. 1E and 1F, when the connector unit 140 is in the removal process, the cable 160 is separated from the connector unit 140. The first engaging portion 123 can latch the connector unit 140, and the pulling portion 125 is configured for the user 900 to exert force (such as inserting the user's finger into the opening 126 and hooking it) and pull the cover 120, causing the connector unit 140 to be driven by the cover 120. Thus, during the removal process of the connector unit 140, the cover 120 of the electronic device 100 not only helps to avoid burns but also prevents electric shock.

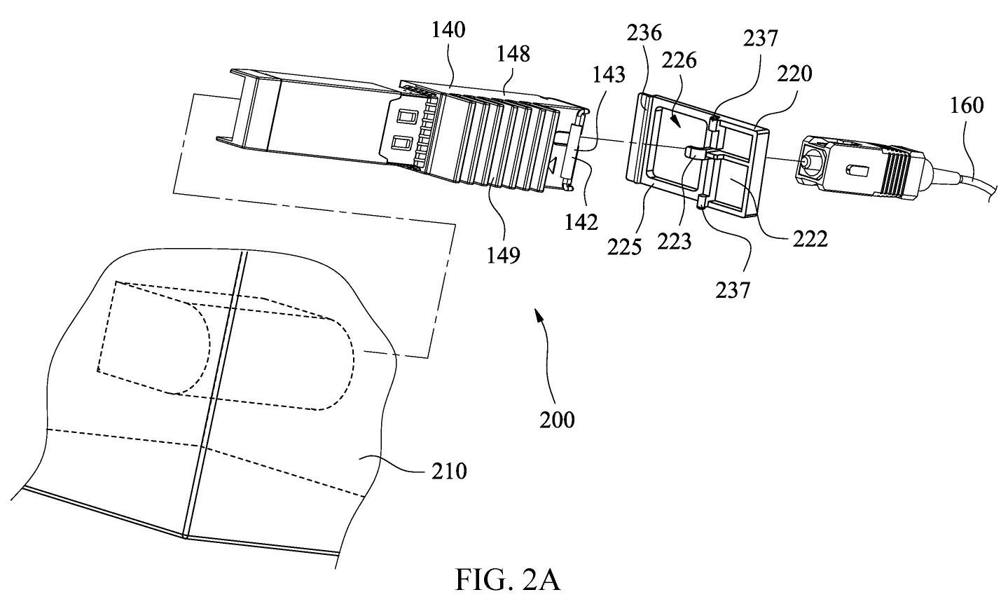

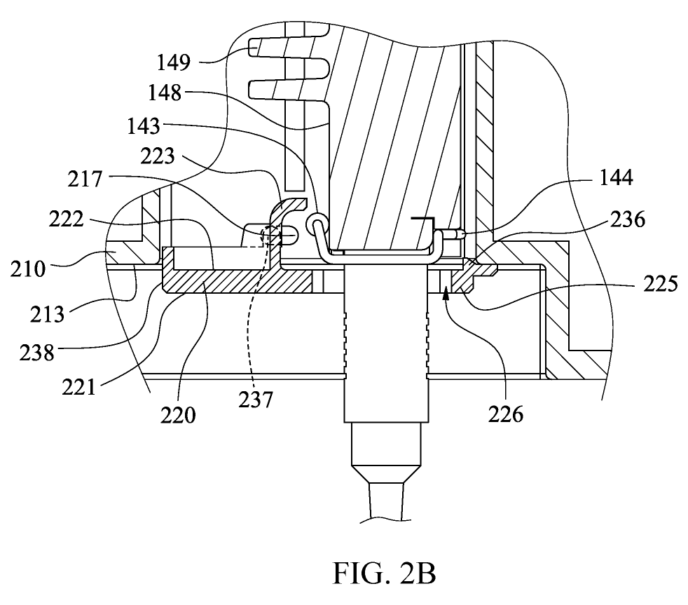

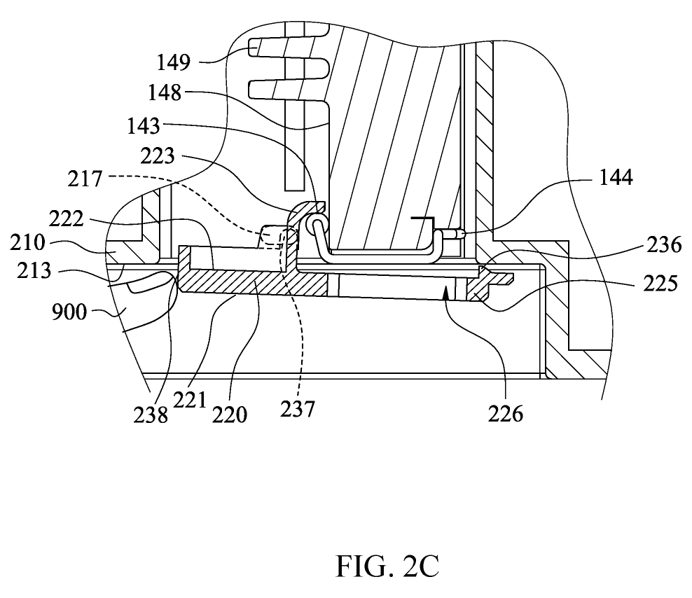

FIG. 2A is an exploded view of a partial of an electronic device 200 according to a second embodiment of the present disclosure, and FIG. 2B is a cross-sectional view of a partial of the electronic device 200 in FIG. 2A after being assembled. Referring to FIGS. 2A and 2B, the electronic device 200 includes a housing 210, a connector unit 140, and a cover 220. The connector unit 140 is disposed in an inner space of the electronic device 200. The cover 220 is correspondingly and adjacently disposed to the connector unit 140, and the cover 220 is connected to the housing 210 and exposed on the outer surface 213 of the housing 210. The cover 220 is configured to contact and drive the connector unit 140, so as to move the connector unit 140 from the inner space of the electronic device 200 to the outer space of the electronic device 200.

Regarding the cover 220, the cover 220 is configured to correspond and be adjacent to the connector unit 140 of the electronic device 200 and includes a first surface 221, a second surface 222, a pulling portion 225, and a first engaging portion 223. The first surface 221 is configured to face an outer space of the electronic device 200. The second surface 222 is disposed opposite to the first surface 221 and configured to face an inner space of the electronic device 200. The pulling portion 225 is an opening structure and includes an opening 226 that penetrates the first surface 221 and the second surface 222. When the connector unit 140 is in a transmission state, the opening 226 is configured for a cable 160 to pass through to connect to the connector unit 140. The first engaging portion 223 is disposed on the second surface 222. In addition, the cover 220 is made of plastic material.

FIG. 2C is a schematic view of the removal process of the connector unit 140 in the electronic device 200 in FIG. 2B. Referring to FIGS. 2A to 2C, after a user 900 performs an action on the cover 220, the cover 220 can contact and drive the connector unit 140. The action includes at least one of a rotation and a movement.

When the action performed by the user 900 on the cover 220 includes movement, the cover 220 includes a moving portion 238 and at least one protrusion 237. In this embodiment, the number of the at least one protrusion 237 is two, but the present disclosure is not limited thereto. The moving portion 238 is disposed on one side of the cover 220. The upper and lower sides of an opening periphery (not labeled) of the housing 210 respectively include two slide rails 217, and the two protrusions 237 are respectively disposed in the two slide rails 217. When the user 900 exerts force on the moving portion 238, the protrusions 237 move along the slide rails 217, causing the cover 220 to move along the outer surface 213 of the housing 210 and contact the connector unit 140. As such, the cover 220 is convenient to install on the electronic device 200 and drive the connector unit 140 during removal.

The cover 220 further includes a first engaging portion 223 disposed on the second surface 222. The first engaging portion 223 can latch and drive the connector unit 140. Further, the second engaging portion 142 is connected to the connector body 148, and the first engaging portion 223 can latch the second engaging portion 142 of the connector unit 140 to drive the connector unit 140. In the second embodiment, the first engaging portion 223 can be a hook, and the first engaging portion 223 can hook the pull handle body 143 of the second engaging portion 142. The number of the first engaging portions 223 can be two, and the two first engaging portions 223 are arranged along the extending direction of the pull handle body 143, as shown in FIG. 2A.

Specifically, the action performed by the user 900 on the cover 220 can further include a slight rotation. When the user 900 slightly presses the moving portion 238 toward the inner space of the electronic device 200, a latching 236 on one side of the cover 220 that is opposite to the moving portion 238 will disengage from a latching state in the inner space to the outer space of the electronic device 200. Then, when the user 900 exerts force on the moving portion 238 toward the right side in FIG. 2C, the protrusion 237 moves along the slide rail 217, causing the cover 220 to move along the outer surface 213 of the housing 210 and contact the connector unit 140. The pulling portion 225 is then used by the user 900 to pull the cover 220, and the connector unit 140 is driven by the cover 220 to move from the inner space of the electronic device 200 to the outer space of the electronic device 200 (similar to FIG. 1F).

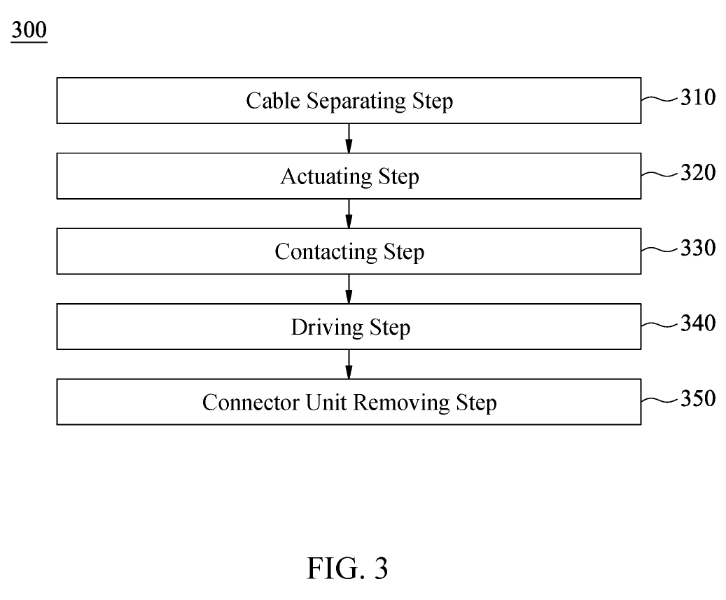

FIG. 3 is a flowchart of a connector unit removing method 300 according to a third embodiment of the present disclosure. Referring to FIGS. 1A to 1F and FIG. 3, the connector unit removing method 300 is used to remove a connector unit 140 from an electronic device 100. The electronic device 100 includes a connector unit 140 and a cover 120. The connector unit 140 is disposed in an inner space of the electronic device 100, and the cover 120 is correspondingly and adjacently disposed to the connector unit 140. The cover 120 is connected to the housing 110 of the electronic device 100 and exposed on the outer surface 113 of the housing 110. The connector unit removing method 300 includes an actuating step 320, a contacting step 330, a driving step 340, and a connector unit removing step 350. The actuating step 320 includes rotating the cover 120 relative to a cover pivot 127 of the cover 120 (as shown in FIG. 1E) or moving the cover 120 along the outer surface 113 of the housing 110. The contacting step 330 includes causing the cover 120 to contact the connector unit 140. The driving step 340 includes causing the cover 120 to drive the connector unit 140 (as shown in FIG. 1F). The connector unit removing step 350 includes moving the connector unit 140 from the inner space of the electronic device 100 to the outer space of the electronic device 100 to remove the connector unit 140 from the electronic device 100. As such, the connector unit removing method 300 facilitates the removal of connector unit 140 by the user 900 without the user 900 having to touch the connector unit 140.

Specifically, the connector unit removing method 300 can further include a cable separating step 310, which includes separating a cable 160 passing through the opening 126 from the connector unit 140, as shown in FIG. 1E. Thus, the opening 126 can provide signal connection functionality when the connector unit 140 is in a transmission state and facilitate the removal process of the connector unit 140.

The contacting step 330 can include latching a second engaging portion 142 of the connector unit 140 with at least one first engaging portion 123 of the cover 120. As such, it is beneficial for the stable movement of the connector unit 140 during removal.

The driving step 340 can include exerting force through a pulling portion 125 of the cover 120 to drive the connector unit 140. The pulling portion 125 is an opening structure and includes an opening 126, as shown in FIG. 1F. Thus, the opening 126 can prevent the user 900 from touching the heating part of the connector unit 140 during the removal process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A cover, configured to correspond and be adjacent to a connector unit of an electronic device, the cover comprising:
a first surface, configured to face an outer space of the electronic device;
a second surface, disposed opposite to the first surface and configured to face an inner space of the electronic device;
a pulling portion, comprising an opening that penetrates the first surface and the second surface, wherein, when the connector unit is in a transmission state, the opening is configured for a cable to pass through to connect to the connector unit; and
at least one first engaging portion, disposed on the second surface.

2. The cover according to claim 1, further comprising:
a cover pivot, wherein the pulling portion and the at least one first engaging portion are respectively disposed on two sides perpendicular to the cover pivot.

3. The cover according to claim 1, wherein, when the connector unit is in a removal process, the cable is separated from the connector unit, the at least one first engaging portion is configured to latch the connector unit, and the pulling portion is configured for a user to exert force and pull the cover, so the connector unit is driven by the cover.

4. An electronic device, comprising:
a housing;
a connector unit, disposed in an inner space of the electronic device; and
a cover, correspondingly and adjacently disposed to the connector unit, wherein the cover is connected to the housing and exposed on an outer surface of the housing;
wherein the cover is configured to contact and drive the connector unit, so the connector unit is moved from the inner space of the electronic device to an outer space of the electronic device.

5. The electronic device according to claim 4, wherein, after a user performs an action on the cover, the cover contacts and drives the connector unit, and the action comprising at least one of a rotation and a movement.

6. The electronic device according to claim 5, wherein the action comprises the rotation, and the cover comprises:
a first surface, facing the outer space of the electronic device;
a second surface, disposed opposite to the first surface and facing the inner space of the electronic device;
a cover pivot, pivotally connected to an opening periphery of the housing; and
a pressing portion, disposed on the first surface;
wherein, when the user presses the pressing portion, the pressing portion rotates relative to the cover pivot from the outer space to the inner space of the electronic device so the cover contacts the connector unit.

7. The electronic device according to claim 6, wherein the cover further comprises:
a pulling portion, wherein the pulling portion and the pressing portion are respectively disposed on two sides perpendicular to the cover pivot;
wherein, when the user presses the pressing portion, the pulling portion rotates relative to the cover pivot to the outer space of the electronic device, the pulling portion is configured for the user to pull the cover, and the connector unit is driven by the cover to move from the inner space of the electronic device to the outer space of the electronic device.

8. The electronic device according to claim 7, wherein the pulling portion comprises an opening that penetrates the first surface and the second surface;
wherein, when the connector unit is in a transmission state, the opening is configured for a cable to pass through to connect to the connector unit;
wherein, when the connector unit is in a removal process, the cable is separated from the connector unit, and the pulling portion is configured for the user to exert force and pull the cover.

9. The electronic device according to claim 6, wherein the cover further comprises:
at least one first engaging portion, disposed on the second surface, wherein the at least one first engaging portion is configured to latch and drive the connector unit.

10. The electronic device according to claim 9, wherein the connector unit comprises:
a connector body; and
a second engaging portion, connected to the connector body, wherein the at least one first engaging portion is configured to latch the second engaging portion to drive the connector unit.

11. The electronic device according to claim 10, wherein the second engaging portion comprises:
a pull handle body, wherein the at least one first engaging portion is configured to hook the pull handle body; and
two pull handle pivoting portions, respectively connected to two ends of the pull handle body and pivotally connected to the connector body.

12. The electronic device according to claim 11, wherein a number of the at least one first engaging portion is two, and the two first engaging portions are arranged along an extending direction of the pull handle body.

13. The electronic device according to claim 5, wherein the action comprises the movement, the cover comprises a moving portion and at least one protrusion, the moving portion is disposed on one side of the cover, an opening periphery of the housing comprises at least one slide rail, and the at least one protrusion is disposed in the at least one slide rail;
wherein, when a user exerts force on the moving portion, the at least one protrusion moves along the at least one slide rail, so the cover moves along the outer surface of the housing and contacts the connector unit.

14. The electronic device according to claim 13, wherein the cover further comprises:
a pulling portion, disposed on another side of the cover, wherein the pulling portion is configured for the user to pull the cover, and the connector unit is driven by the cover to move from the inner space of the electronic device to the outer space of the electronic device.

15. The electronic device according to claim 4, wherein the connector unit is an optical fiber transmission connector unit.

16. The electronic device according to claim 4, wherein the connector unit comprises a heat dissipation structure made of a metal material, and the cover is made of a plastic material.

17. A connector unit removing method, for removing a connector unit from an electronic device, wherein the electronic device comprises the connector unit and a cover, the connector unit is disposed in an inner space of the electronic device, the cover is correspondingly and adjacently disposed to the connector unit, and the cover is connected to a housing of the electronic device and exposed on an outer surface of the housing, the connector unit removing method comprising:
an actuating step, comprising rotating the cover relative to a cover pivot of the cover, or moving the cover along the outer surface of the housing;
a contacting step, comprising causing the cover to contact the connector unit;
a driving step, comprising causing the cover to drive the connector unit; and
a connector unit removing step, comprising moving the connector unit from the inner space of the electronic device to an outer space of the electronic device to remove the connector unit from the electronic device.

18. The connector unit removing method according to claim 17, wherein the contacting step comprises latching a second engaging portion of the connector unit with at least one first engaging portion of the cover.

19. The connector unit removing method according to claim 17, wherein the driving step comprises exerting force on the cover through a pulling portion of the cover to drive the connector unit, wherein the pulling portion comprises an opening.

20. The connector unit removing method according to claim 19, further comprising:
a cable separating step, comprising separating a cable passing through the opening from the connector unit.
